(19) United States
(12) Patent Application Publication
(10) Pub. No.: US 2010/0151321 A1
(43) Pub. Date: Jun. 17, 2010

(54) NEGATIVE ELECTRODE FOR COIN-SHAPED LITHIUM SECONDARY BATTERY, METHOD FOR PRODUCING THE SAME, AND COIN-SHAPED LITHIUM SECONDARY BATTERY

(76) Inventors: Teruaki Yamamoto, Osaka (JP); Tomohiro Ueda, Nara (JP); Youko Sano, Osaka (JP); Yasuhiko Bito, Osaka (JP)

Correspondence Address: MCDERMOTT WILL & EMERY LLP, 600 13TH STREET, NW, WASHINGTON, DC, 20005-3096, US

(21) Appl. No.: 12/067,930

(22) PCT Filed: Nov. 9, 2006
(86) PCT No.: PCT/JP2006/322370

§ 371 Date: Mar. 24, 2008

(30) Foreign Application Priority Data
Nov. 9, 2005 (JP) 2005-324478

(51) Int. Cl. H01M 4/48; H01M 4/02; H01M 2/16; H01M 4/04; H01M 4/12

(52) U.S. Cl. 429/218.1; 429/209; 429/246; 264/104

(57) ABSTRACT

An object of the present invention resides in that under the use of an active material capable of attaining a high capacity, the volume expansion of the negative electrode is alleviated, the maintenance of the structure of the negative electrode is achieved, and the degradation of the battery capacity is suppressed. The present invention relates to a negative electrode for a coin-shaped lithium secondary battery, a coin-shaped lithium secondary battery including the negative electrode, and a method for producing the negative electrode for a coin-shaped lithium secondary battery, wherein: the negative electrode includes a molded negative electrode including a negative electrode active material capable of absorbing and desorbing lithium; the molded negative electrode is of a coin shape having two flat faces and a side edge, and has cracks along the thickness direction thereof; at least one of the two flat faces has recessed portions; and the cracks start from the recessed portions.

### TECHNICAL FIELD

The present invention relates to a coin-shaped lithium secondary battery, in particular, to a negative electrode for a coin-shaped lithium secondary battery and the method for producing the same.

### BACKGROUND ART

A lithium secondary battery has such features that the electromotive force thereof is high and the energy density thereof is high. Lithium secondary batteries are used as a main power source of mobile communication devices and portable electronic devices, and additionally, demand for lithium secondary batteries as a memory back-up power source has been increased year by year. Further, as portable electronic devices and the like have been developed remarkably, lithium secondary batteries having high energy density have been strongly demanded from the viewpoint of further downsizing, enhancing performance and maintenance-free design and the like of the devices.

Accordingly, in order to enhance the capacity of lithium secondary batteries, Si materials and Sn materials, as negative electrode materials, having higher theoretical capacity than carbonaceous materials have attracted attention. However, crystalline Si and Sn undergo at the largest approximately four-fold volume change due to the expansion and contraction caused by the absorption and desorption of lithium (ion) during charging and discharging. Consequently, the Si and Sn undergo distortion caused by the volume change to be pulverized, and hence the negative electrode structure is destroyed. Additionally, Si itself is low in electron conductivity, and hence a Si-containing lithium secondary battery is remarkably degraded in cycle life property and rate property. Here, it is to be noted that the negative electrode is generally composed of a material mixture containing an active material, a conductive agent, a binder and the like.

Accordingly, it has been proposed that an alloy in which Si is added with another element such as a transition metal is used as an active material. Such an alloy contains a Si phase and an alloy phase composed of Si and the transition metal. By controlling the crystallite sizes of these phases, the volume change of the active material can be alleviated (for example, Patent Document 1).

Additionally, it has been proposed that a thin film of an active material is formed on a current collector with the roughened surface thereof and the current collector is made to have a strength exceeding the stress due to the volume expansion during charging. In the thin film, a plurality of columnar portions are generated due to the stress caused by the initial volume expansion. Consequently, it comes to be possible to alleviate the stress due to the volume change during the subsequent charging and discharging, and hence the adhesion between the current collector and the active material can be maintained (for example, Patent Document 2).

Further, it has been proposed that by using a mask, active material portions and voids are formed on a current collector in a predetermined pattern, a stress alleviation due to the voids is thereby made possible, and the electrode degradation due to repetition of charging and discharging is thereby suppressed (for example, Patent Document 3).

Patent Document 1: Japanese Patent Laid-Open Publication No. 2004-103340

Patent Document 2: Japanese Patent Laid-Open Publication No. 2002-260637

Patent Document 3: Japanese Patent Laid-Open Publication No. 2004-103474

### DISCLOSURE OF INVENTION

### Problem To be Solved by the Invention

When a negative electrode is made of the active material of Patent Document 1, the pulverization of the active material can be suppressed. However, the volume expansion of the active material is large, and hence it is difficult to maintain the structure of the negative electrode.

The negative electrode of Patent Document 2 is required to make the thickness of the current collector comparable with the thickness of the thin film for the purpose of resisting to the initial stress. Accordingly, no drastic capacity increase of the whole negative electrode can be expected.

The negative electrode of Patent Document 3 requires a step of forming a mask based on a fine pattern and a step of removing the mask, and hence is not practical.

An object of the present invention resides in that under the use of an active material capable of enhancing the capacity, the volume expansion of the negative electrode is alleviated, the maintenance of the negative electrode structure is achieved, and the degradation of the battery capacity is suppressed.

### Means for solving the Problem

As a result of a diligent study, the present inventors have found that in a coin-shaped lithium secondary battery, by positively dividing a coin-shaped molded negative electrode into sections each having a predetermined size, the subsequent maintenance of the shape of the negative electrode becomes satisfactory, and disconnection of the current collecting paths along the thickness direction of the negative electrode is alleviated. The present invention is based on this finding; by forming cracks in the coin-shaped molded negative electrode along the thickness direction thereof, the division of the molded negative electrode is positively induced, and further, the way of division is controlled.

The present invention relates to a negative electrode for a coin-shaped lithium secondary battery which includes a molded negative electrode containing a negative electrode active material capable of absorbing and desorbing lithium, wherein the molded negative electrode is of a coin shape having two flat faces and a side edge, and has cracks along the thickness direction thereof.

The present invention also relates to the negative electrode for a coin-shaped lithium secondary battery wherein at least one of the two flat faces has recessed portions and the cracks start from the recessed portions.

The present invention further relates to the negative electrode for a coin-shaped lithium secondary battery wherein the two flat faces each have recessed portions, the cracks start from the recessed portions, and the recessed portions of one flat face and the recessed portions of the other flat face are at least partially opposite to each other.

The present invention also relates to a coin-shaped lithium secondary battery including a positive electrode, a positive electrode case that contains the positive electrode, a negative electrode, a negative electrode case that contains the negative electrode, and a separator interposed between the positive electrode and the negative electrode, wherein: the positive electrode includes a molded positive electrode including a positive electrode active material capable of absorbing and desorbing lithium; the negative electrode includes a molded negative electrode including a negative electrode active material capable of absorbing and desorbing lithium; and the molded negative electrode is of a coin shape having two flat faces and a side edge, and has cracks along the thickness direction thereof, wherein at least one of the flat faces has recessed portions, and the cracks start from the recessed portions.

The present invention also relates to a coin-shaped lithium secondary battery including a positive electrode, a positive electrode case that contains the positive electrode, a negative electrode, a negative electrode case that contains the negative electrode, and a separator interposed between the positive electrode and the negative electrode, wherein: the positive electrode includes a molded positive electrode including a positive electrode active material capable of absorbing and desorbing lithium; the negative electrode includes a molded negative electrode including a negative electrode active material capable of absorbing and desorbing lithium; the molded negative electrode is of a coin shape having two flat faces and a side edge, and has cracks along the thickness direction thereof; and the negative electrode case has raised portions on the face thereof opposite to the molded negative electrode, and the cracks start from the portions where the raised portions are in contact with the molded negative electrode.

In the coin-shaped lithium secondary battery of the present invention, the recessed portions are preferably formed in at least one pattern selected from the group consisting of a linear shape, a circular shape, a radial shape, a lattice shape, a polygonal shape and a honeycomb shape. The raised portions are also preferably formed in at least one pattern selected from the group consisting of a linear shape, a circular shape, a radial shape, a lattice shape, a polygonal shape and a honeycomb shape.

The negative electrode active material preferably includes at least one selected from the group consisting of an alloy of a transition metal and Si, Si, SiOₓ (0<x<2), Sn and SnOₓ (0<x≦2).

The crystallite size of the negative electrode active material is preferably 20 nm or less.

The present invention relates to a method for producing a negative electrode for a coin-shaped lithium secondary battery including the steps of: (i) preparing a negative electrode material mixture including a negative electrode active material capable of absorbing and desorbing lithium; (ii) preparing a coin-shaped molded negative electrode having two flat faces and a side edge by press molding the negative electrode material mixture; and (iii) forming cracks along the thickness direction of the molded negative electrode.

The step (ii) of preparing the molded negative electrode can include a step of forming recessed portions on at least one of the two flat faces.

The step (iii) of forming the cracks can include, for example, the following steps.

(a) A step in which a negative electrode case having a face having raised portions opposite to the molded negative electrode is supplied, and the molded negative electrode is pressure bonded to the face having raised portions.

(b) A step of pressure bonding lithium metal to the molded negative electrode supported by a jig having raised portions.

(c) A step of pressure bonding lithium metal to the molded negative electrode supported by a jig having recessed portions.

(d) A step in which a negative electrode case having a face with lithium metal attached thereto opposite to the molded negative electrode is supplied, and the molded negative electrode is pressure bonded to the lithium metal by pushing the molded negative electrode with a jig having raised portions.

(e) A step in which a negative electrode case having a face with lithium metal attached thereto opposite to the molded negative electrode is supplied, and the molded negative electrode is pressure bonded to the lithium metal by pushing the molded negative electrode with a jig having recessed portions.

### EFFECT OF THE INVENTION

The negative electrode of the present invention is improved in followability to volume change, is easy in maintaining the negative electrode structure and easy in ensuring the current collecting paths. Consequently, there can be provided a coin-shaped lithium secondary battery small in capacity degradation (excellent in cycle properties) and high in capacity. In the present invention, a high capacity material can be used as an active material, and hence a drastic enhancement of the capacity can be made as compared to conventional lithium secondary batteries using carbonaceous materials. Additionally, the lithium secondary battery of the present invention can achieve a drastic extension of life as compared to conventional lithium secondary batteries using Al plates.

### BRIEF DESCRIPTION OF DRAWINGS

FIG. 1 is a vertical sectional view of a coin-shaped lithium secondary battery according to an embodiment of the present invention;

FIG. 2 is a top view of a molded negative electrode according to an embodiment of the present invention;

FIG. 3 is an oblique perspective view of the molded negative electrode according to the embodiment of the present invention;

FIG. 4 is a vertical sectional view of the molded negative electrode according to the embodiment of the present invention;

FIG. 5 is a top view of a molded negative electrode according to an embodiment of the present invention;

FIG. 6 is a top view of a molded negative electrode according to an embodiment of the present invention;

FIG. 7 is a top view of a molded negative electrode according to an embodiment of the present invention;

FIG. 8 is an oblique perspective view of a molded negative electrode according to an embodiment of the present invention;

FIG. 9 is a vertical sectional view of the molded negative electrode according to the embodiment of the present invention;

FIG. 10 is an oblique perspective view of a molded negative electrode according to an embodiment of the present invention;

FIG. 11 is a vertical sectional view of the molded negative electrode according to the embodiment of the present invention;

FIG. 12 is an oblique perspective view of a molded negative electrode according to an embodiment of the present invention;

FIG. 13 is a sectional view of the molded negative electrode according to the embodiment of the present invention;

FIG. 14 is a schematic sectional view illustrating a method for preparing a negative electrode according to an embodiment of the present invention;

FIG. 15 is a schematic sectional view illustrating a method for preparing a negative electrode according to an embodiment of the present invention;

FIG. 16 is a schematic sectional view illustrating a method for preparing a negative electrode according to an embodiment of the present invention;

FIG. 17 is a schematic sectional view illustrating a method for preparing a negative electrode according to an embodiment of the present invention;

FIG. 18 is a vertical sectional view of a molded negative electrode according to an embodiment of the present invention;

FIG. 19 is a vertical sectional view of a molded negative electrode according to an embodiment of the present invention;

FIG. 20 is a vertical sectional view of a molded negative electrode according to an embodiment of the present invention;

FIG. 21 is a vertical sectional view of a molded negative electrode according to an embodiment of the present invention;

FIG. 22 is a vertical sectional view of a molded negative electrode according to an embodiment of the present invention;

FIG. 23 is a vertical sectional view of a molded negative electrode according to an embodiment of the present invention; and

FIG. 24 is a vertical sectional view of a molded negative electrode according to a comparative example of the present invention.

### BEST MODE FOR CARRYING OUT THE INVENTION

The negative electrode for a coin-shaped lithium secondary battery of the present invention includes a molded negative electrode including a negative electrode active material capable of absorbing and desorbing lithium. The molded negative electrode includes a molded body made of a material mixture, a plate member made of a negative electrode active material and the like. Here, a material mixture is a mixture including the negative electrode active material as an essential component. The material mixture can include as optional components a conductive agent, a binder and the like.

The molded negative electrode is of a coin shape having two flat faces and a side edge, and has cracks along the thickness direction thereof. Here, the cracks along the thickness direction mean the cracks extending from one flat face to the other flat face. The cracks along the thickness direction are preferably formed uniformly in the whole molded body. The molded negative electrode has cracks along the thickness direction thereof, and hence the followability to the volume change of the negative electrode is improved and the maintenance of the negative electrode structure and the ensuring of the current collecting paths are made easy.

The molded negative electrode is preferably divided into 5 to 100 sections by the cracks. Additionally, the average size of a section is preferably 1% by volume to 30% by volume of the molded body before undergoing cracking. When the size of a section is too large, the molded body after the division is further finely divided during charge and discharge cycles, and hence the current collecting paths along the thickness direction are partially disconnected, so that the effect of the division becomes insufficient as the case may be. On the other hand, when the size of a section is too small, the molded negative electrode is finely divided, and hence the current collecting paths along the thickness direction tend to be disconnected as the case may be.

For example, by forming recessed portions on at least one of the flat faces of the molded negative electrode, the cracks along the thickness direction are generated so as to start from the recessed portions due to the stress subsequently applied to the molded body. The cracks along the thickness direction can be generated inside the battery case or outside the battery case. For example, a molded body having recessed portions is contained in the battery case so as to complete the battery. Thereafter, the completed battery is charged or discharged, and then a stress due to the expansion or contraction of the negative electrode active material is applied to the molded body. Consequently, inside the battery case, the cracks are generated so as to start from the recessed portions.

When the two flat faces of the molded negative electrode each have recessed portions, the recessed portions of one flat face and the recessed portions of the other flat face are preferably at least partially opposite to each other. For example, the recessed portions of one flat face and the recessed portions of the other flat face preferably have symmetric shapes with respect to the plane parallel to the flat faces of the molded body and passing through the center of the molded body. Thus, the direction of the cracks and the thickness direction of the molded body are nearly parallel to each other, and in the individual sections divided by the cracks, the continuity of the current collecting paths along the thickness direction is maintained. When the recessed portions of one of the two flat faces and the recessed portions of the other of the two flat faces are not opposite to each other, cracks tilted away from the thickness direction of the molded body are generated. In this case, the continuity of the individual sections along the thickness direction is partially lost.

For the purpose of forming cracks along the thickness direction of the molded body, raised portions may be provided on the face of the negative electrode case opposite to (abutting on) the molded body. When recessed portions are formed on the molded negative electrode, the molded negative electrode tends to become brittle. On the other hand, when raised portions are formed on the face of the negative electrode case opposite to the molded body, the cracks along the thickness direction can be efficiently generated without forming the recessed portions on the molded negative electrode. Thus, without the fear of decreasing the strength of the molded negative electrode, the object of the present invention can be achieved. In this case, the cracks are generated so as to start from the portions where the raised portions are in contact with the molded negative electrode.

The recessed portions of the flat face of the molded body are preferably formed in at least one pattern selected from the group consisting of a linear shape, a circular shape, a radial shape, a lattice shape, a polygonal shape and a honeycomb shape. The raised portions of the face of the negative electrode case opposite to the molded body are also preferably formed in at least one pattern selected from the group consisting of a linear shape, a circular shape, a radial shape, a lattice shape, a polygonal shape and a honeycomb shape. Examples of the polygon include a triangle, a quadrilateral and a hexagon although the polygon is not particularly limited. Examples of the linear shape include a stripe shape, and examples of the circular shape include a concentric shape. The recessed portions are each preferably of a groove shape and the raised portions are each preferably of a rib shape.

Among these patterns, when the pattern is of a polygonal shape, the pattern is preferably of a network shape. Particularly preferable are recessed or raised portions having a pattern of closest-arranged triangles, closest-arranged squares (lattice shape) and closest-arranged regular hexagons (honeycomb shape). The recessed or raised portions formed of closest-arranged triangles are favorable in the sense that cracks tend to be formed around the angular portions. The lattice-shaped or honeycomb-shaped, recessed or raised portions are favorable in the sense that the shape maintenance of the sections divided by the cracks is most satisfactory. Conceivably, in the case of the lattice-shaped or honeycomb-shaped, recessed or raised portions, excessively fine sections are hardly generated when the molded body is divided by the cracks.

The flat face of the molded negative electrode is preferably divided into 5 to 100 sections due to the recessed portions. Additionally, the average area of a section is preferably 1% to 30% of the area of the flat face before undergoing cracking.

Similarly, the face of the negative electrode case opposite to the molded body is preferably divided into 5 to 100 sections due to the raised portions. Additionally, the average area of a section is preferably 1% to 30% of the area of the opposite face before undergoing cracking.

The negative electrode for a lithium secondary battery of the present invention can be prepared, for example, by the following method.

### Step (i)

A negative electrode material mixture including a negative electrode active material capable of absorbing and desorbing lithium is prepared. As the negative electrode material mixture, for example, a mixture including a negative electrode active material, a conductive agent and a binder is used. As the conductive agent, for example, carbon black, carbon fiber and the like are used. As the binder, for example, fluororesin, polyacrylic acid, polyacrylate, carboxylmethyl cellulose, styrene-butadiene rubber polymer and the like are used.

### Step (ii)

The negative electrode material mixture is pressure molded to prepare a coin-shaped molded negative electrode (pellet) having two flat faces and a side edge. At this time, on at least one of the two flat faces, predetermined recessed portions may be formed simultaneously. In other words, the step of preparing a coin-shaped molded negative electrode by pressure molding the negative electrode material mixture and the formation of the recessed portions can be carried out simultaneously.

Step (iii)

Cracks are formed along the thickness direction of the molded negative electrode. When the recessed portions are formed on at least one flat face of the molded negative electrode, the cracks along the thickness direction are preferably generated by the volume change of the negative electrode active material during charging and discharging. When no recessed portions are formed on the molded negative electrode, the cracks may be formed during assembling the battery. A step of beforehand dividing the molded negative electrode with a cutter or the like is also included in the step of forming the cracks.

When the step (iii) of forming the cracks is implemented as follows, a molded negative electrode having no recessed portions on the flat faces thereof can be used. Needless to say, a molded negative electrode having recessed portions on the flat face may also be used.

### Step (a)

A negative electrode case having a face having raised portions opposite to the molded negative electrode is prepared. And, the molded negative electrode is pressure bonded to the face having the raised portions of the negative electrode case. It is to be noted that the recessed portions may be formed on the molded negative electrode either during assembling the battery (in other words, during pressure bonding of the molded negative electrode to the face having the raised portions of the negative electrode case) or during charging and discharging after completion of the battery. Alternatively, recessed portions are not necessarily needed to be formed on the molded negative electrode. The object of the present invention is achieved by generating the cracks along the thickness direction in the molded negative electrode so as to start from the raised portions of the negative electrode case. It is to be noted that when the cracks are formed before assembling of the battery, the molded negative electrode tends to be partially exfoliated, and hence the cracks are preferably generated along the thickness direction of the molded negative electrode during assembling the battery or later.

### Step (b)

Lithium metal is pressure bonded to the molded negative electrode supported by a jig having raised portions. When lithium metal is pressure bonded to the molded negative electrode, a jig for pushing the lithium metal and the jig for supporting the molded negative electrode are used. The raised portions are formed on the surface of the jig for supporting the molded negative electrode. Thus, when the molded negative electrode and lithium foil are pressure bonded together, cracks along the thickness direction are generated in the molded negative electrode so as to start from the raised portions.

### Step (c)

Lithium metal is pressure bonded to the molded negative electrode supported by a jig having recessed portions. When lithium metal is pressure bonded to the molded negative electrode, a jig for pushing the lithium metal and the jig for supporting the molded negative electrode are used. The recessed portions are formed on the surface of the jig for supporting the molded negative electrode. Thus, when the molded negative electrode and lithium foil are pressure bonded together, cracks along the thickness direction are generated in the molded negative electrode so as to start from the recessed portions.

### Step (d)

The molded negative electrode is pressure bonded to lithium metal by pushing the molded negative electrode with a jig having raised portions. The lithium metal is beforehand pressure bonded to the face of the negative electrode case opposite to the molded negative electrode. When lithium metal is pressure bonded to the molded negative electrode, a jig for pushing the molded negative electrode is used. The raised portions are formed on the surface of the jig 11 for pushing the molded negative electrode. The molded negative electrode is placed on the lithium metal, and pushed with the jig having the raised portions, and thus the lithium metal is pressure bonded. During the pressure bonding, the cracks along the thickness direction are generated in the molded negative electrode so as to start from the raised portions.

### Step (e)

The molded negative electrode is pressure bonded to lithium metal by pushing the molded negative electrode with a jig having recessed portions. The lithium metal is beforehand pressure bonded to the face of the negative electrode case opposite to the molded negative electrode. When lithium metal is pressure bonded to the molded negative electrode, a jig for pushing the molded negative electrode is used. The recessed portions are formed on the surface of the jig for pushing the molded negative electrode. The molded negative electrode is placed on the lithium metal, and pushed with the jig having the recessed portions, and thus the lithium metal is pressure bonded. During the pressure bonding, the cracks 8 along the thickness direction are generated in the molded negative electrode so as to start from the recessed portions.

The spacing of the recessed portions of the flat face of the molded negative electrode or the jig, or the spacing of the raised portions of the negative electrode case or the jig is preferably 0.1 mm to 3.0 mm and more preferably 0.2 to 2.1 mm. Here, the spacing of the recessed or raised portions means as follows: when the recessed or raised portions are of a stripe shape or of a concentric shape, the spacing is the shortest distance between the adjacent recessed or raised portions; when the recessed or raided portion is of a circle shape, the spacing means the radius of the circle; and when the recessed or raised portions are of a polygon shape, the spacing means the height of the polygon. When the spacing of the recessed or raised portions is less than 0.1 mm, the molded negative electrode is too finely divided by the cracks, and hence the current collecting paths along the thickness direction tend to be disconnected as the case may be. On the other hand, when the spacing is larger than 3.0 mm, the molded body after the division is further finely divided during charge and discharge cycles, the current collecting paths along the thickness direction are partially disconnected, and hence the effect of the division becomes insufficient as the case may be. It is to be noted that herein the individual numerical values are based on the assumption that the thickness of the molded negative electrode is approximately 0.3 mm.

The optimal value of the spacing of the recessed portions of the flat face of the molded negative electrode or the jig, or the spacing of the raised portions of the negative electrode case or the jig is dependent on the aspect ratios between the thickness of the molded negative electrode and the widths of the individual sections after division due to the cracks. When the thickness of the molded negative electrode is represented by T, the spacing of the recessed or raised portions is optimally 0.7T to 7T. For example, when the thickness of the molded negative electrode is 0.2 mm, the optimal value of the spacing of the recessed or raised portions is 0.14 to 1.4 mm.

The depth of the recessed portions of the flat face of the molded negative electrode or the jig, or the height of the raised portions of the negative electrode case or the jig is preferably 0.01 mm to 0.1 mm and more preferably 0.03 to 0.06 mm. When the depth of the recessed portions or the height of the raised portions is less than 0.01 mm, the crack formation undergoes variations, and hence the molded negative electrode is hardly divided uniformly as the case may be. Alternatively, when the depth of the recessed portions or the height of the raised portions is larger than 0.1 mm, the strength of the molded negative electrode is decreased, and hence the handling of the molded negative electrode becomes difficult during assembling the battery as the case may be. It is to be noted that herein the individual numerical values are based on the assumption that the thickness of the molded negative electrode is approximately 0.3 mm.

The optimal value of the depth of the recessed portions or the height of the raised portions is dependent on the thickness of the molded negative electrode. When the thickness of the molded negative electrode is represented by T, the depth of the recessed portions or the height of the raised portions is optimally 0.1T to 0.2T. For example, when the thickness of the molded negative electrode is 0.2 mm, the optimal value of the depth of the recessed portions or the height of the raised portions is optimally 0.02 to 0.04 mm.

When the recessed portions are formed on the supporting jig, the depth of the recessed portions is preferably as deep as possible; the depth is satisfactorily 0.01 mm or more, and preferably 0.03 mm or more. When the depth of the recessed portions of the jig is less than 0.01 mm, the crack formation undergoes variations, and hence the molded negative electrode is hardly divided uniformly. It is to be noted that herein the individual numerical values are based on the assumption that the thickness of the molded negative electrode is approximately 0.3 mm. The optimal value of the depth of the recessed portions is dependent on the thickness of the molded negative electrode. When the thickness of the molded negative electrode is represented by T, the depth of the recessed portions is optimally 0.1T or more. For example, when the thickness of the molded negative electrode is 0.2 mm, the optimal value of the depth of the recessed portions or the height of the raised portions is optimally 0.02 mm or more.

The width (maximum width) of the recessed portions of the flat face of the molded negative electrode or the jig, or the raised portions of the negative electrode case or the jig is preferably as small as possible. When the depth of the recessed portions or the height of the raised portions is represented by H, the width is preferably 1.5H or less and more preferably 1.0H or less. When the width is larger than 1.5H, it becomes difficult to control the cracks so as to develop along the thickness direction and the current collecting paths along the thickness direction tend to be disconnected as the case may be.

As described above, by forming the recessed portions on the flat face of the molded negative electrode, or by forming the raised portions or the recessed portions on the face of the negative electrode case or the jig opposite to the molded body, the division of the molded negative electrode is induced so as to start from the recessed portions or the raised portions. After the division has once been made, the maintenance of the shape of the molded negative electrode becomes satisfactory, and the disconnection of the current collecting paths along the thickness direction is alleviated. The reasons for achieving these effects are not clear, but conceivably, these effects are associated with the alleviation, attributable to the division of the molded negative electrode, of the accumulation of the stress due to the expansion and contraction of the active material.

As the negative electrode active material, Si materials and Sn materials are preferably used. For example, at least one selected from the group consisting of an alloy of a transition metal and Si, Si, SiOₓ, (0<x<2), Sn and SnOₓ (0<x≦2) is preferably used. In the case of the alloy of a transition metal and Si, examples of the transition metal include Cr, Mn, Fe, Co, Ni, Cu, Mo, Ag, Ti, Zr, Hf and W. Among these, Ti is preferable. A Si—Ti alloy (for example, TiSi₂) is favorable because of the high electron conductivity thereof. It is to be noted that the alloy of a transition metal and Si include the intermetallic compound phase and the Si phase inert to lithium. An alloy particle including two or more such phases is preferable from the viewpoint of making the enhancement of the capacity and the suppression of the volume expansion compatible with each other.

The state of the negative electrode active material is not particularly limited, but is preferably an amorphous state, a microcrystalline state, or a mixed state composed of an amorphous region and a microcrystalline region, and most preferably a mixed state composed of an amorphous region and a microcrystalline region. An amorphous state refers to a state in which the X-ray diffraction image (diffraction pattern) obtained with CuKα line does not have any definite peaks to be assigned to crystallographic planes, but has only broad diffraction image. A microcrystalline state refers to a state in which the crystallite size is 20 nm or less. These states can be directly observed with a transmission electron microscope (TEM). The crystallite sizes can also be determined from the half widths of the peaks obtained from the X-ray diffraction analysis by using the Scherrer equation. When the crystallite size is larger than 20 nm, the mechanical strength of the active material particles cannot follow the volume change during charging and discharging, the particle fracture or the like is caused, and the current collecting conditions are degraded as the case may be.

Examples of a method for obtaining a negative electrode active material in an amorphous state, a microcrystalline state or a mixed state composed of an amorphous region and a microcrystalline region include a mechanical pulverization and mixing method (mechanical alloying method). In the mechanical alloying method, a device such as a ball mill, a vibration mill or a planetary ball mill is used. A vibration mill is most preferable from the viewpoint of the magnitude of the exerting gravitational acceleration and the easiness in size-enlargement.

The specific surface area of the negative electrode active material is not particularly limited, but preferably falls within a range from 0.5 to 20 m²/g. When the specific surface area is less than 0.5 m²/g, the contact area with the electrolyte is decreased and the charge and discharge efficiency is degraded as the case may be. When the specific surface area exceeds 20 m²/g, the reactivity with the electrolyte becomes excessive, and hence the irreversible capacity is increased as the case may be.

The mean particle size of the negative electrode active material is not particularly limited, but preferably falls within a range from 0.1 to 10 μm. When the mean particle size is less than 0.1 μm, the specific surface area becomes large, the reactivity with the electrolyte is made excessive and the irreversible capacity is increased as the case may be. When the mean particle size exceeds 10 μm, the specific surface area becomes small, the contact area with the electrolyte is reduced, and the charge and discharge efficiency is degraded as the case may be.

When a Si material or a Sn material is used, it is preferable to form a coating film including an oxide of Si or Sn on the surface of the negative electrode active material. Examples of the method for forming the coating film include a method in which while the negative electrode active material is being stirred in a hermetically-sealed vessel, oxygen is slowly introduced into the vessel. In this case, the treating time can be shortened by cooling the hermetically-sealed vessel by using a heat dissipation mechanism such as a water-cooling jacket and by thereby suppressing the temperature rise of the active material. Examples of an apparatus provided with such a hermetically-sealed vessel having stirring function include a vibration dryer and a kneader.

The coin-shaped lithium secondary battery of the present invention includes, in addition to the negative electrode and the negative electrode case that contains the negative electrode, the positive electrode, the positive electrode case that contains the positive electrode, and the separator interposed between the positive electrode and the negative electrode. Additionally, the coin-shaped lithium secondary battery generally includes a lithium ion conducting electrolyte. The positive electrode includes a molded positive electrode including a positive electrode active material capable of absorbing and desorbing lithium. For the positive electrode (molded positive electrode), the positive electrode case and the lithium ion conducting electrolyte, the same members as those of conventional coin-shaped lithium secondary batteries can be used.

In the following, the present invention will be specifically described by way of Examples. However, the subject matter of the present invention is not limited to these Examples.

### Example 1

A coin-shaped lithium secondary battery as shown in FIG. 1 was produced.

### (i) Synthesis of Positive Electrode Active Material

Manganese dioxide and lithium hydroxide were mixed together in a molar ratio of 2:1, and the mixture was baked in air at 400° C. for 12 hours to obtain lithium manganate. This was used as a positive electrode active material.

### (ii) Positive Electrode Preparation

The lithium manganate as the positive electrode active material, acetylene black as a conductive agent and an aqueous dispersion of polytetrafluoroethylene as a binder were mixed together in a weight ratio of 88:6:6 in terms of the solid contents, to obtain a positive electrode material mixture. The positive electrode material mixture was molded into a coin-shaped pellet of 4 mm in diameter and 1.0 mm in thickness, and the pellet thus obtained was dried at 250° C. for 12 hours to prepare a molded positive electrode 4.

(iii) Synthesis of Negative Electrode Active Material

As the negative electrode active material, a Si—Ti alloy was synthesized. A Si powder and a Ti powder were mixed together so as for the molar element ratio to be 74.5:25.5. Then, 1.7 kg of the mixture was placed in a vibration ball mill (Model FV-20, manufactured by Chuo Kakohki Co., Ltd.) which was provided with a stainless steel vessel having an internal volume of 64 L, together with 300 kg of stainless steel balls of 1 inch in diameter. Then, the air inside the vessel was replaced with argon gas, and thereafter, a 60-hour mechanical alloying was carried out at an amplitude of 8 mm and a frequency of 1200 rpm to obtain the Si—Ti alloy.

The results of an XRD observation revealed that the Si—Ti alloy included at least a Si phase and a TiSi₂ phase, and the Si phase was amorphous and the TiSi₂ phase was a microcrystalline phase. By using the position and the half width of the XRD peak and the Scherrer equation, the crystallite size of the TiSi₂ phase was calculate and was found to be 15 nm. The weight ratio of the Ti—Si phase to the Si phase was found to be 4:1 under the assumption that all the Ti was involved in the formation of TiSi₂.

The Si—Ti alloy was collected into the hermetically-sealed vessel in a vibration dryer provided with a stirring unit (Model VU30, manufactured by Chuo Kakohki Co., Ltd.) while the argon atmosphere was being maintained. While the Si—Ti alloy was being stirred by vibration, a mixed gas of argon and oxygen was intermittently introduced into the hermetically-sealed vessel over 1 hour. In the course of this operation, the hermetically-sealed vessel was cooled so that the temperature of the Si—Ti alloy might not exceed 100° C. Thus, on the surface of the Si—Ti alloy, a coating film containing an oxide of Si was formed. Thereafter, the Si—Ti alloy was sieved in such a way that the particle size of the alloy was regulated not to exceed 63 μm, and the thus sieved alloy was used as the negative electrode active material.

### (iv) Negative Electrode Preparation

The Si—Ti alloy as the negative electrode active material, carbon black as the conductive agent and polyacrylic acid as the binder were mixed together in a weight ratio of 100:20:10 to obtain a negative electrode material mixture. The negative electrode material mixture was molded into a coin-shaped pellet of 4 mm in diameter and 0.3 mm in thickness by using a pair of molds. In this molding, on the surface of one mold, rib-shaped raised portions of 0.05 mm both in width and in height were beforehand formed in a lattice-shaped pattern in which the length of a side of the square was 0.8 mm. Herewith, at the same time of the preparation of the molded negative electrode (pellet), recessed portions of 0.05 mm both in width and in depth were formed on one flat face of the molded negative electrode in a lattice-shaped pattern having a spacing of 0.8 mm. Thereafter, the pellet was dried at 200° C. for 12 hours to prepare a molded negative electrode 6.

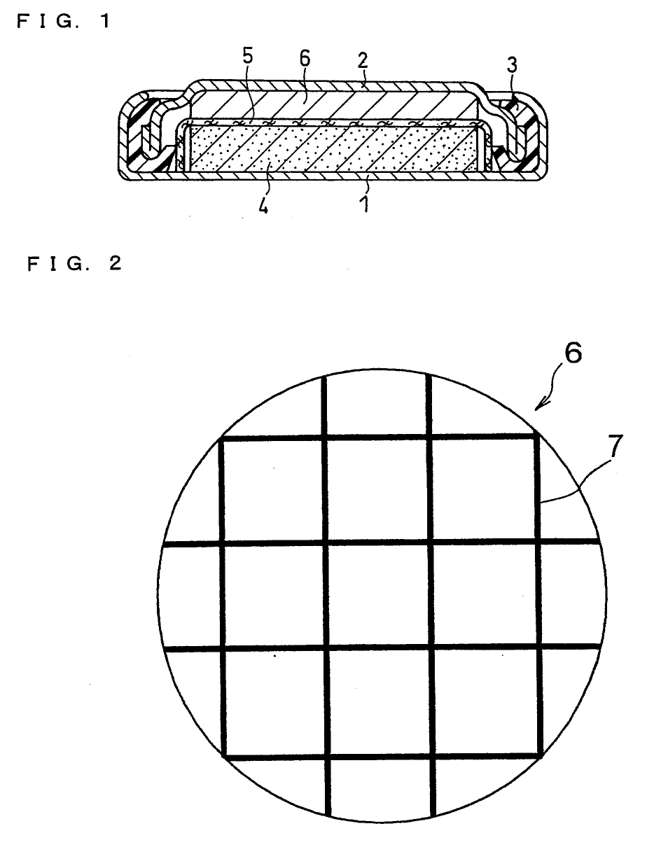

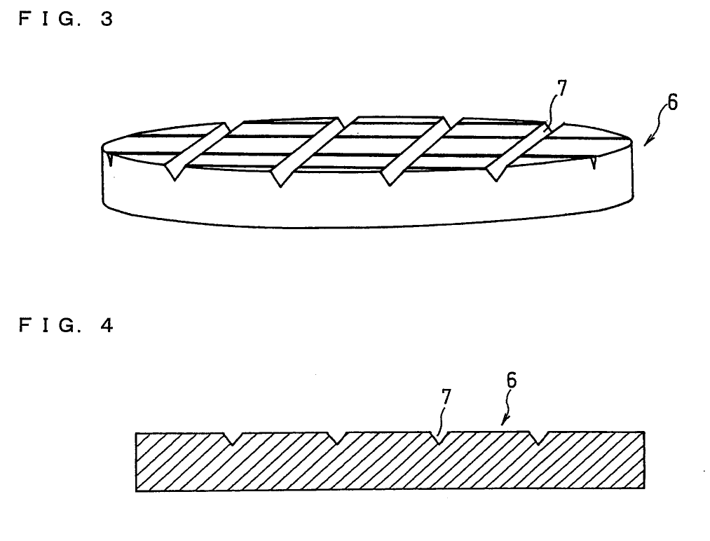

As shown in FIG. 2, on one flat face of the molded negative electrode 6, lattice-shaped recessed portions 7 were formed. The recessed portions 7 divided the flat face of the molded negative electrode into 21 sections and an average area of one section was approximately 5% of the area of the flat face before division.

### (v) Electrolyte Preparation

In a 1:1:1 by volume mixed solvent of propylene carbonate (PC), ethylene carbonate (EC) and dimethyl ether (DME), LiN(CF₃SO₂)₂ as a lithium salt was dissolved in an concentration of 1 mol/L to obtain a lithium ion conducting electrolyte.

### (vi) Test Battery Production

FIG. 1 is a vertical sectional view of a produced coin-shaped lithium secondary battery. In present Example, a battery having a dimension of 6.8 mm in diameter and 2.1 mm in thickness was produced. In FIG. 1, the positive electrode case 1 doubles as a positive electrode terminal, and is made of a stainless steel excellent in corrosion resistance. The negative electrode case 2 doubles as a negative electrode terminal and is made of the same stainless steel as that of the positive electrode case 1. A gasket 3 insulates the positive electrode case 1 from the negative electrode case 2 and is made of polypropylene. Pitch is applied to the portions of the gasket 3 respectively in contact with the positive electrode case 1 and the negative electrode case 2. Between the molded positive electrode 4 and the molded negative electrode 6, a separator 5 made of a polypropylene non-woven fabric is disposed.

First, the molded positive electrode 4 was placed on the center of the positive electrode case 1, and the separator 5 was disposed thereon. Next, 15 μL of the electrolyte was poured over the separator 5. By using a predetermined jig, lithium foil, for alloying the negative electrode active material with lithium, was pressure bonded to the flat face having no recessed portions of the molded negative electrode 6, which flat face was made to be opposite to the separator 5. The flat face having recessed portions of the molded negative electrode 6 was placed so as to face the negative electrode case 2 (the upper side in FIG. 1). In the presence of the electrolyte, the negative electrode active material electrochemically absorbed the lithium supplied from the lithium foil to form a lithium alloy. The apparent volume (volume including internal voids) of the molded negative electrode having absorbed lithium was expanded to be 1.6 times the volume of the molded negative electrode before the absorption of lithium.

The test battery produced as described above was referred to as a battery A1a.

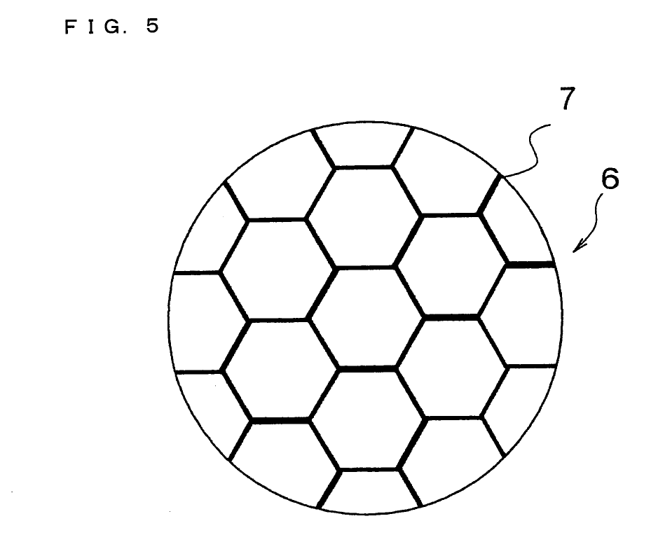

A test battery A1b was produced in the same manner as in the case of the battery Ala except that honeycomb-shaped recessed portions as shown in FIG. 5 were formed. The depth and the width of the recessed portions were made to be the same as those in the battery Ala. The height of the regular hexagon was set at 0.8 mm.

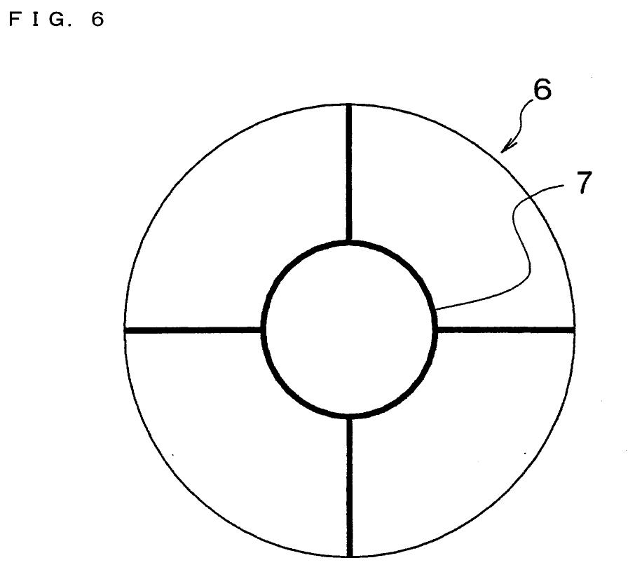

A test battery A1c was produced in the same manner as in the case of the battery Ala except that recessed portions as a combination of a circular shape and a radial shape as shown in FIG. 6 were formed. The depth and the width of the recessed portions were made to be the same as those in the battery A1a. The diameter of the circular recessed portion was set at 2.0 mm.

A test battery A1d was produced in the same manner as in the case of the battery Ala except that only a circular recessed portion as shown in FIG. 7 was formed. The depth and the width of the recessed portion were made to be the same as those in the battery A1a. The diameter of the circular recessed portion was set at 2.0 mm.

It is to be noted that when the molded negative electrode 6 and the lithium foil were pressure bonded together, a recessed portion was formed on the surface of the jig for supporting the molded negative electrode or the jig for pushing the molded negative electrode. Consequently, when the molded negative electrode 6 and the lithium foil were pressure bonded together, radial cracks heading to the outer circumference of the circle were generated. Also when a raised portion was formed on the surface of the jig when the molded negative electrode 6 and the lithium foil were pressure bonded together, similarly radial cracks heading to the outer circumference of the circle were generated.

### Example 2

A battery A2 was produced in the same manner as in Example 1 except that the flat face having the recessed portions of the molded negative electrode 6 was placed so as to face the separator (the under side in FIG. 1).

### Example 3

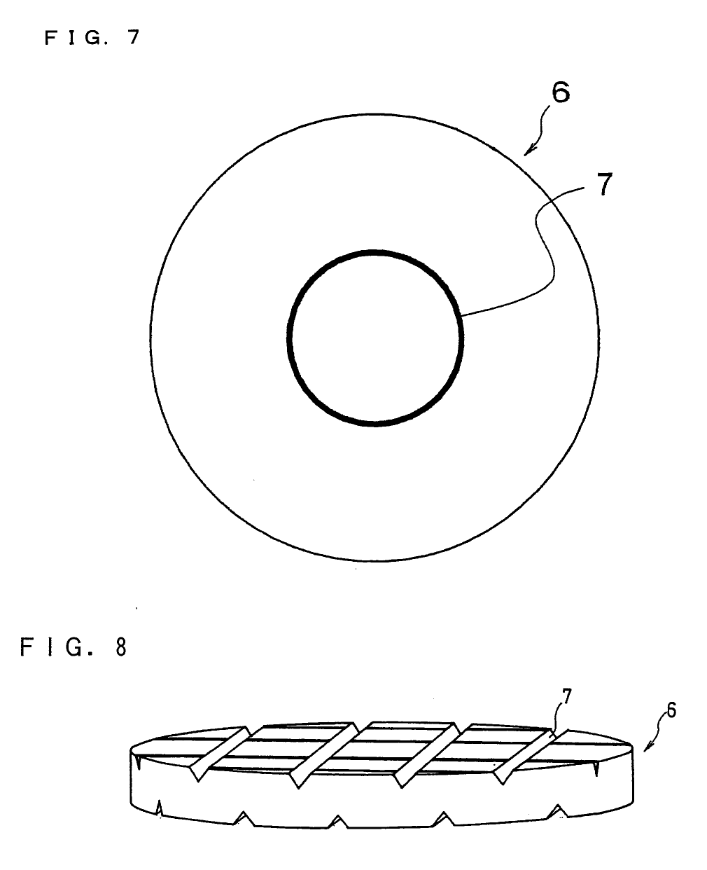

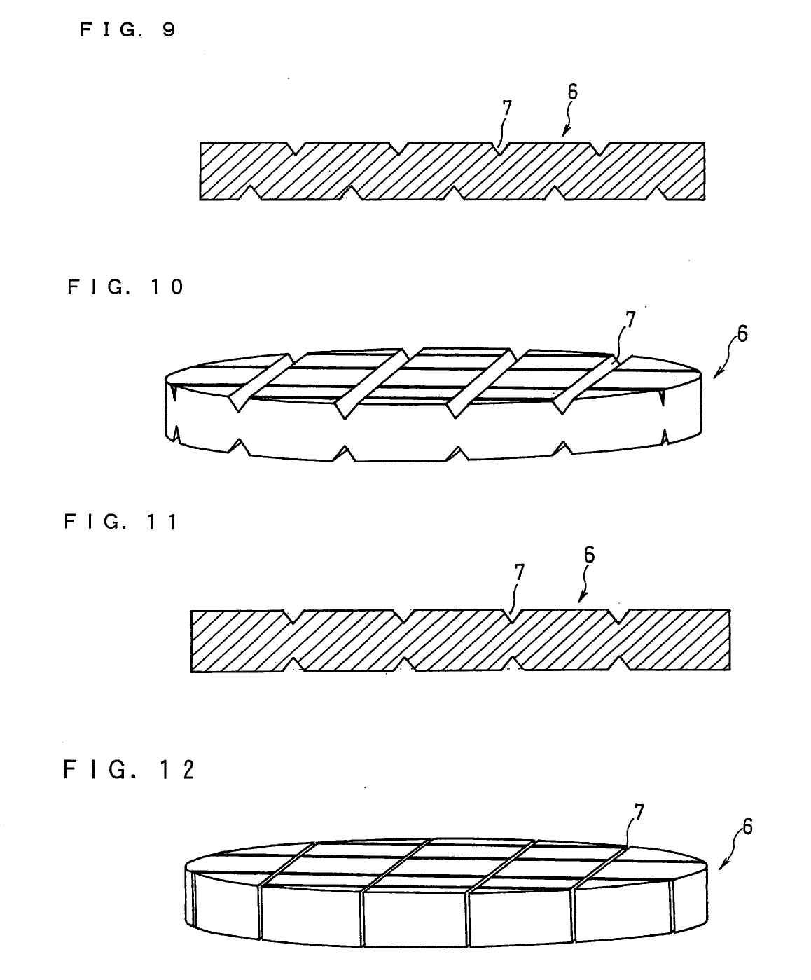

When the molded negative electrode was prepared, the same lattice-shaped raised portions as those on the one mold were formed on the surface of the other mold, and thus lattice-shaped recessed portions having a spacing of 0.8 mm were formed on the both flat faces of the molded negative electrode. However, as shown in FIGS. 8 and 9, the recessed portions of the one flat face and the recessed portions of the other flat face were relatively displaced so that the recessed portions of the one flat face might not be opposite to those of the other flat face. A battery A3 was produced in the same manner as in Example 1 except that the molded negative electrode thus prepared was used.

### Example 4

A battery A4 was produced in the same manner as in Example 3 except that the recessed portions of one flat face and the recessed portions of the other flat face were made opposite to each other as shown in FIGS. 10 and 11.

### Example 5

A battery A5 was produced in the same manner as in Example 1 except that when the negative electrode case was molded, raised portions 9 of 0.05 mm both in height and in width were formed in a lattice-shaped pattern having a spacing of 0.8 mm on the face of the negative electrode case 2 opposite to the molded negative electrode 6. No recessed portions were formed on the molded negative electrode.

### Example 6

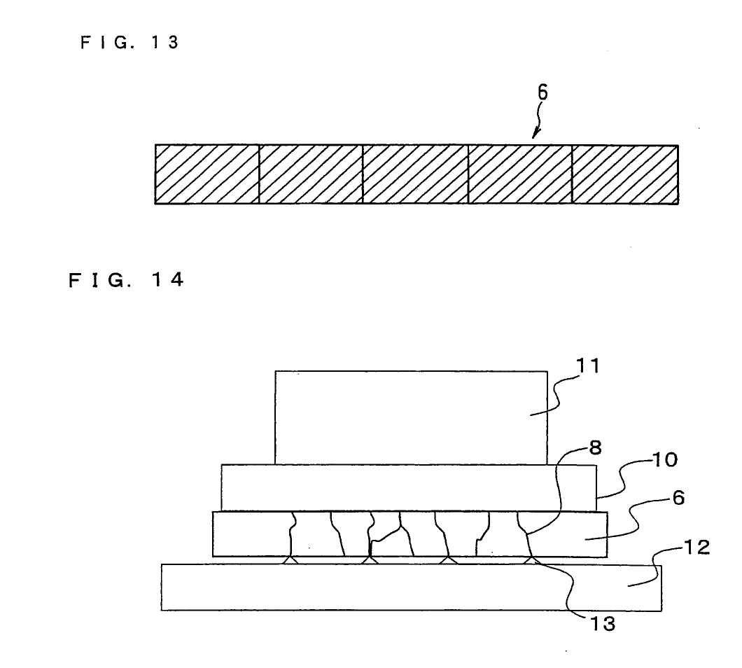

A molded negative electrode 6 having no recessed portions on the both flat faces thereof was prepared by using molds having no lattice-shaped raised portions. As shown in FIGS. 12 and 13, the molded negative electrode 6 was divided into 21 sections with a cutter knife in conformity with the lattice-shaped pattern having a spacing of 0.8 mm. A battery A6 was produced in the same manner as in Example 1 except that the divided molded negative electrode was rearranged on the lithium foil when the battery was assembled.

### Example 7

A molded negative electrode 6 having no recessed portions on the both flat faces thereof was prepared. When lithium foil 10 was pressure bonded to the molded negative electrode 6, a jig 11 for pushing the lithium foil 10 and a jig 12 for supporting the molded negative electrode 6 were used as shown in FIG. 14. Additionally, on the surface of the jig 12 for supporting the molded negative electrode 6, raised portions 13 of 0.05 mm both in height and in width were formed in a lattice-shaped pattern having a spacing of 0.8 mm. Accordingly, when the molded negative electrode 6 and the lithium foil 10 were pressure bonded together, cracks 8 along the thickness direction were generated in the molded negative electrode so as to start from the raised portions 13. A battery A7 was produced otherwise in the same manner as in Example 1.

### Example 8

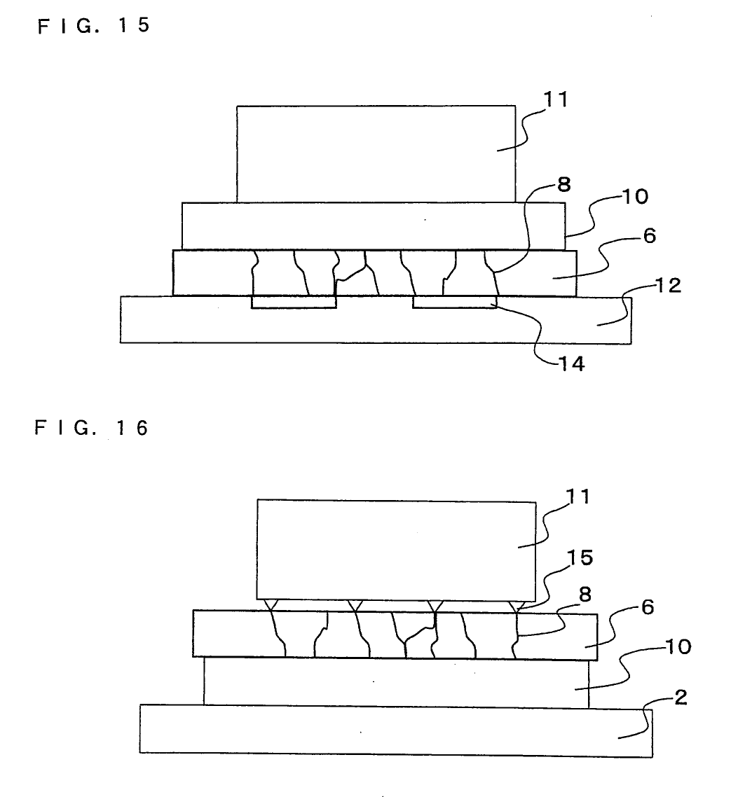

A molded negative electrode 6 having no recessed portions on the both flat faces thereof was prepared. When lithium foil 10 was pressure bonded to the molded negative electrode 6, a jig 11 for pushing the lithium foil 10 and a jig 12 for supporting the molded negative electrode 6 were used as shown in FIG. 15. Additionally, on the surface of the jig 12 for supporting the molded negative electrode 6, recessed portions 14 of 1.0 mm in depth were formed in a concentric shape in a region of 0.7 to 1.4 mm in diameter. Accordingly, when the molded negative electrode 6 and the lithium foil 10 were pressure bonded together, cracks 8 along the thickness direction were generated in the molded negative electrode so as to start from the recessed portions 14. A battery A8 was produced otherwise in the same manner as in Example 1.

### Example 9

A molded negative electrode 6 having no recessed portions on the both flat faces thereof was prepared. To the face of the negative electrode case 2 opposite to the molded negative electrode 6, lithium foil 10 was beforehand pressure bonded. When the lithium foil 10 was pressure bonded to the molded negative electrode 6, a jig 11 for pushing the molded negative electrode 6 was used as shown in FIG. 16. Additionally, on the surface of the jig 11 for pushing the molded negative electrode 6, raised portions 15 of 0.05 mm both in height and in depth were formed in a lattice-shaped pattern having a spacing of 0.8 mm. The molded negative electrode 6 was placed on the lithium foil 10, and pressure bonded to the lithium foil 10 by pushing the molded negative electrode 6 with the jig having the raised portions. In this pressure bonding, cracks 8 along the thickness direction were generated in the molded negative electrode 6 so as to start from the raised portions 15. A battery A9 was produced otherwise in the same manner as in Example 1.

### Example 10

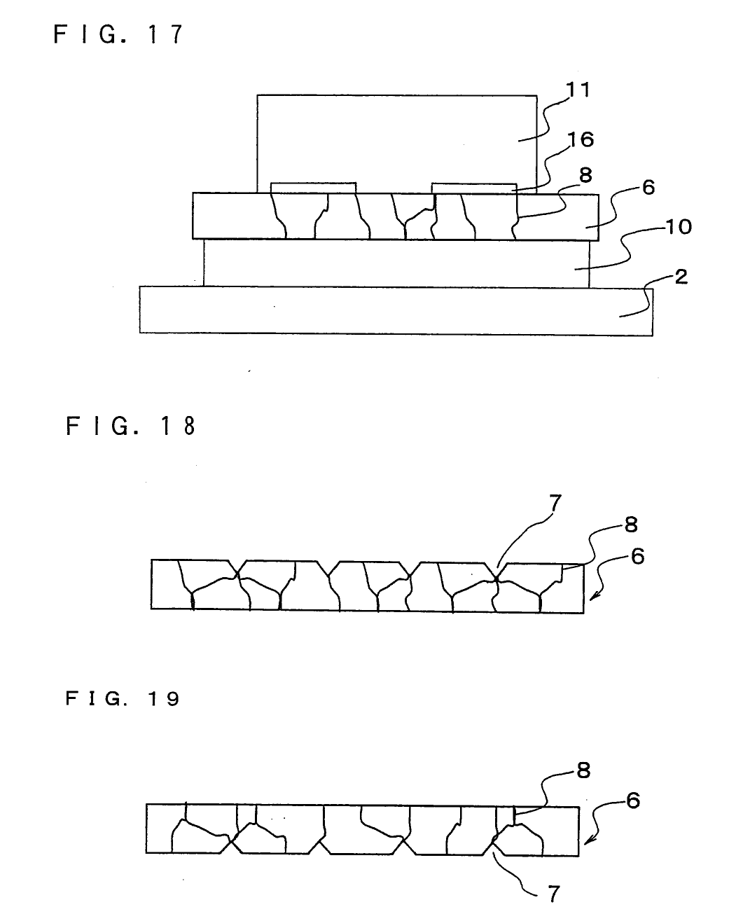

A molded negative electrode 6 having no recessed portions on the both flat faces thereof was prepared. To the face of the negative electrode case 2 opposite to the molded negative electrode 6, lithium foil 10 was beforehand pressure bonded. When the lithium foil 10 was pressure bonded to the molded negative electrode 6, a jig 11 for pushing the molded negative electrode 6 was used as shown in FIG. 17. Additionally, on the surface of the jig 11 for pushing the molded negative electrode 6, recessed portions 16 of 1.0 mm in depth were formed in a concentric shape in a region of 0.7 to 1.4 mm in diameter. The molded negative electrode 6 was placed on the lithium foil 10, and pressure bonded to the lithium foil 10 by pushing the molded negative electrode 6 with the jig having the recessed portions. In this pressure bonding, cracks 8 along the thickness direction were generated in the molded negative electrode 6 so as to start from the recessed portions 16. A battery A10 was produced otherwise in the same manner as in Example 1.

### Comparative Example 1

A battery A0a was produced in the same manner as in Example 1 except that a molded negative electrode 6 having no recessed portions on the both flat faces was prepared and used.

### Comparative Example 2

A battery A0b was produced in the same manner as in Comparative Example 1 except that the position for attaching the lithium foil was shifted to the negative electrode case-facing side of the molded negative electrode.

### [Evaluation]

For each of the above-described batteries, the capacity maintenance rate and the internal resistance increase rate were evaluated by means of the following methods.

In a constant-temperature room set at 20° C., for each battery, a constant current charge and discharge was repeated 100 cycles at a charge current and a discharge current both set at 0.05 C (1 C is 1 hour-rate current) within a battery voltage range from 2.0 to 3.3 V. The capacity maintenance rate was defined as the ratio of the 100-th cycle discharge capacity to the first cycle discharge capacity. Additionally, the internal resistance increase rate was calculated from the ratio of the 100-th cycle internal resistance of the battery to the first cycle internal resistance of the battery. The internal resistance of the battery was measured by means of the 1 kHz alternating current impedance method. The results thus obtained are shown in Table 1. Additionally, each battery after 100 cycles was subjected to an observation based on the cross-sectional X-ray CT. FIGS. 18 to 24 show the conditions of the cracks in the negative electrode molded bodies of Examples 1 to 6 and Comparative Example 1.

TABLE 1

| | | | Capacity maintenance rate | Resistance increase rate |
|---|---|---|---|---|
| | Battery | Feature | (%) after 100 cycles | (%) after 100 cycles |
| Example 1 | A1a | Recessed portions on molded electrode/ | 90 | 15 |
| | | negative electrode case-facing side | | |
| Example 2 | A2 | Recessed portions on molded electrode/ | 85 | 22 |
| | | separator-facing side | | |
| Example 3 | A3 | Recessed portions on molded electrode/ | 82 | 27 |
| | | both faces/non-opposite | | |
| Example 4 | A4 | Recessed portions on molded electrode/ | 95 | 8 |
| | | both faces/opposite | | |
| Example 5 | A5 | Raised portions on negative | 88 | 18 |
| | | electrode case | | |
| Example 6 | A6 | Divided beforehand with cutter | 95 | 8 |
| Example 7 | A7 | Raised portions on supporting jig | 92 | 12 |
| Example 8 | A8 | Recessed portions on supporting jig | 90 | 15 |
| Example 9 | A9 | Raised portions on pushing jig | 82 | 27 |
| Example 10 | A10 | Recessed portions on pushing jig | 80 | 30 |
| Comparative | A0a | — | 67 | 50 |
| Example 1 | | | | |
| Comparative | A0b | — | 42 | 87 |
| Example 2 | | | | |

First, the battery A0a is described (see FIG. 24). According to the cross-sectional X-ray CT of the battery A0a, the cracks 8 in the molded negative electrode 6 were formed much along the direction parallel to the faces (the direction perpendicular to the thickness direction) of the molded body. This means that the continuity of the current collecting paths along the thickness direction of the molded body is broken. Around the center on the separator-facing side of the molded body, the molded body was comparatively finely divided. Conceivably, this is associated with that the alloying of the negative electrode active material and lithium started from the separator-facing side on which the lithium foil was disposed, and stress tended to be accumulated around the center of the molded body. Additionally, the capacity maintenance rate after 100 cycles was as low as 67%, and the internal resistance increase rate of the battery was as large as 50%.

In the molded negative electrode of the battery A0b, the capacity maintenance rate after 100 cycles gave a further lower value of 42%, and the internal resistance increase rate of the battery gave a further larger value of 87%. The finely divided face on the lithium foil-attached side was opposite to the negative electrode case, and conceivably the electrical contact between the molded body and the negative electrode case was degraded.

In the molded negative electrode of the battery Ala, the continuity break of the current collecting paths along the thickness direction was found to be drastically suppressed. Additionally, approximately 50% of the cracks generated in the molded body were found to start from the recessed portions 7 (see FIG. 18). The capacity maintenance rate after 100 cycles was as high as 90%, and the internal resistance increase rate of the battery was satisfactorily as low as 15%. This is associated with the fact that by forming the recessed portions on the negative electrode case 2—facing side of the molded negative electrode 6, the cracks were generated preferentially along the thickness direction of the molded body. Conceivably, the size and shape of the sections generated by the cracks were made appropriate by the recessed portions 7, and in particular, the continuity of the current collecting paths along the thickness direction was effectively maintained. For the batteries A1b, A1c and A1d, similar results were obtained.

In the molded negative electrode of the battery A2, the continuity break of the current collecting paths along the thickness direction was found to be further suppressed as compared to the battery Ala. Additionally, approximately 60% of the cracks generated in the molded body were found to start from the recessed portions 7 (see FIG. 19). However, there was found a tendency that, as compared to the battery Ala, the molded body was finely divided on the negative electrode case-facing side (the upper side in FIG. 19). The capacity maintenance rate and the internal resistance increase rate were drastically improved as compared to the battery A0a, but were slightly worse than those of the battery Ala. Conceivably this is because the fine division of the molded body on the side thereof facing the negative electrode case doubling as the negative electrode terminal caused the increase of the contact resistance between the molded electrode and the negative electrode case. The fine division of the molded electrode on the negative electrode case-facing side thereof is ascribable to the fact that the recessed portions were located on the separator-facing side, and conceivably, the effect of the recessed portions on the negative electrode case-facing side of the molded body was diminished.

In the molded negative electrode of the battery A3, approximately 80% of the cracks were generated so as to start from the recessed portions on the both flat faces (see FIG. 20). The capacity maintenance rate and the internal resistance increase rate were drastically improved as compared to the battery A0a, but were worse than those of the batteries A1 and A2. This is conceivably because the recessed portions on the both flat faces were not opposite to each other, and hence, the cracks generated between the recessed portions of the upper face and those of the reverse face were tilted away from the thickness direction of the molded body, so that the continuity of the current collecting paths along the thickness direction was partially lost.

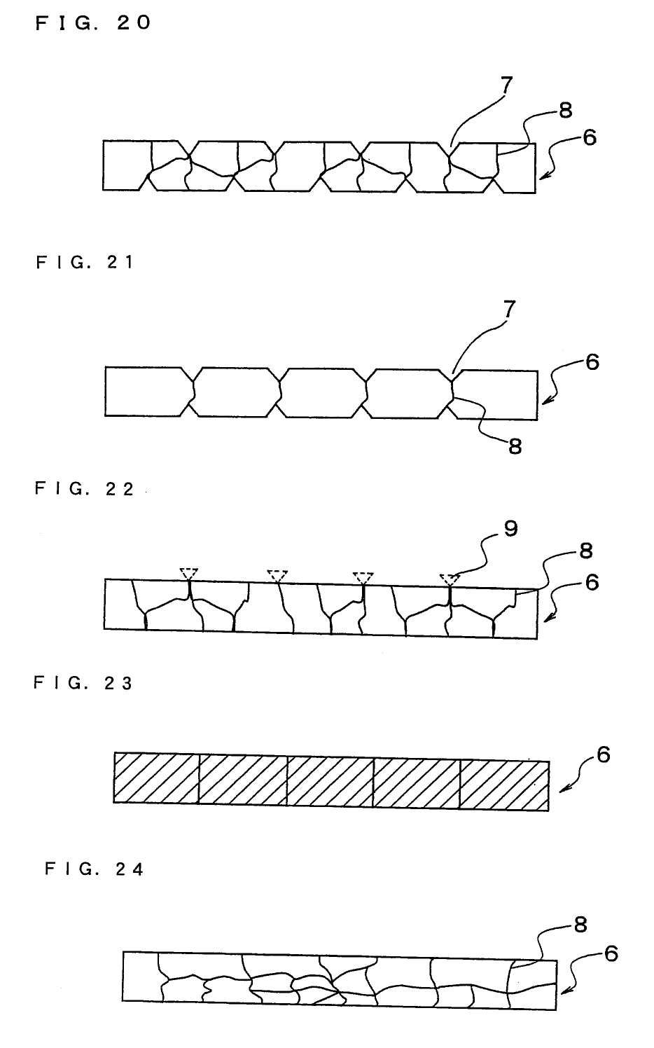

In the molded negative electrode of the battery A4, approximately 90% of the cracks were generated so as to start from the recessed portions on the both flat faces (see FIG. 21). The capacity maintenance rate and the internal resistance increase rate were 95% and 8%, respectively, to give the most satisfactory results. This is conceivably because the recessed portions on the both flat faces were opposite to each other, and hence the cracks were approximately parallel to the thickness direction of the molded body, so that the continuity of the current collecting paths along the thickness direction was maintained.

The division conditions of the molded negative electrode of the battery A5 were nearly the same as those of the battery Ala (see FIG. 22). However, partial cracking was also found in the molded positive electrode. The capacity maintenance rate and the internal resistance increase rate were drastically improved as compared to the battery A0a, but resulted in slightly worse results than those of the batter A1a. This is conceivably because when the molded negative electrode was expanded during charging so as to apply a pressure to the molded positive electrode, the molded positive electrode was cracked, or the separator or the lithium foil was crushed.

In the molded negative electrode of the battery A6, additional cracks were little generated, and the continuity along the thickness direction was maintained (see FIG. 23). The capacity maintenance rate and the internal resistance increase rate were found to be comparable with those of the battery A4.

The battery characteristics of the batteries A7 and A8 were found to be slightly better than those of the battery A5. This is because the cracks had been already generated in the molded negative electrode before the molded negative electrode was alloyed with lithium (see FIGS. 14 and 15), and thus, conceivably the cracking of the molded negative electrode during being alloyed with lithium was suppressed. This is also conceivably because no cracking of the molded positive electrode was caused.

The battery characteristics of the batteries A9 and A10 were slightly worse than those of the batteries A7 and A8. This is similar to the fact that the battery characteristics of the battery A0b was worse than those of the battery A0a, and is conceivably because due to the coating film formation and cracking of the molded body, the resistance between the molded body and the negative electrode case was increased (see FIGS. 16 and 17).

From the above-described results, it has been able to be verified that by forming the recessed portions on the flat face(s) of the molded negative electrode, by forming the raised portions on the face of the negative electrode case opposite to the molded negative electrode, or by beforehand forming the cracks in the molded negative electrode along the thickness direction thereof, the continuity of the current collecting paths along the thickness direction of the molded negative electrode can be ensured, and there are provided advantageous effects in improving the capacity maintenance rate and in suppressing the resistance increase rate. It has also been able to be verified that by forming the recessed portions so as to be opposite to each other on the both flat faces of the molded negative electrode and by dividing the molded negative electrode during charging and discharging, as in the battery A4, there can be obtained performances comparable to those of the case where a beforehand divided molded body is used as in the battery A6.

### Example 11

A battery B4 was produced in the same manner as in Example 4 except that scale-like graphite (mean particle size: 10 μm) was used as the negative electrode active material in place of the Si—Ti alloy. In other words, in present Example, there was used a molded negative electrode having the recessed portions opposite to each other on the both flat faces thereof. The contents of the carbon black and polyacrylic acid in the negative electrode material mixture were the same as those in Example 1.

### Comparative Example 3

A battery B0 was produced in the same manner as in Comparative Example 1 except that scale-like graphite (mean particle size: 10 μm) was used as the negative electrode active material in place of the Si—Ti alloy. In other words, in present Comparative Example, there was used a molded negative electrode having no recessed portions on the both flat faces thereof.

### Example 12

A battery C4 was produced in the same manner as in Example 4 except that a blanked piece of a 0.25 mm thick aluminum plate was used as the molded negative electrode. In other words, in present Example, there was used a molded negative electrode having the recessed portions opposite to each other on the both flat faces thereof. From the results of an XRD observation (the position and the half width of the peak), the crystallite size of the aluminum was calculated by using the Scherrer equation to be 36 nm.

### Comparative Example 4

A battery C0 was produced in the same manner as in Comparative Example 1 except that a blanked piece of a 0.25 mm thick aluminum plate was used as it was as the molded negative electrode. In other words, in present Comparative Example, there was used a molded negative electrode having no recessed portions on the both flat faces thereof.

### Example 13

A battery D4 was produced in the same manner as in Example 4 except that in the synthesis of the negative electrode active material, only a Si powder was used in place of the mixture of a Si powder and a Ti powder, and mechanical alloying was carried out with a vibration ball mill device in the same manner as in Example 1. In other words, in present Example, there was used a molded negative electrode having the recessed portions opposite to each other on the both flat faces thereof. By using the results of an XRD observation (the position and the half width of the peak) and the Scherrer equation, the crystallite size of the silicon was calculated to be 10 nm.

### Comparative Example 5

A battery D0 was produced in the same manner as in Comparative Example 1 except that the same negative electrode active material as in Example 13 was used. In other words, in present Comparative Example, there was used a molded negative electrode having no recessed portions on the both flat faces thereof.

### Example 14

A battery E4 was produced in the same manner as in Example 4 except that in the synthesis of the negative electrode active material, only a Sn powder was used in place of the mixture of a Si powder and a Ti powder, and mechanical alloying was carried out with a vibration ball mill device in the same manner as in Example 1. In other words, in present Example, there was used a molded negative electrode having the recessed portions opposite to each other on the both flat faces thereof. By using the results of an XRD observation (the position and the half width of the peak) and the Scherrer equation, the crystallite size of the tin was calculated to be 15 nm.

### Comparative Example 6

A battery E0 was produced in the same manner as in Comparative Example 1 except that the same negative electrode active material as in Example 14 was used. In other words, in present Comparative Example, there was used a molded negative electrode having no recessed portions on the both flat faces thereof.

### Example 15

A battery F4 was produced in the same manner as in Example 4 except that in the synthesis of the negative electrode active material, a SiO powder was used in place of the mixture of a Si powder and a Ti powder, and mechanical alloying was carried out with a vibration ball mill device in the same manner as in Example 1. In other words, in present Example, there was used a molded negative electrode having the recessed portions opposite to each other on the both flat faces thereof. By using the results of an XRD observation (the position and the half width of the peak) and the Scherrer equation, the crystallite size was calculated to be 12 nm.

### Comparative Example 7

A battery F0 was produced in the same manner as in Comparative Example 1 except that the same negative electrode active material as in Example 15 was used. In other words, in present Comparative Example, there was used a molded negative electrode having no recessed portions on the both flat faces thereof.

### Example 16

A battery G4 was produced in the same manner as in Example 4 except that in the synthesis of the negative electrode active material, a SnO₂ powder was used in place of the mixture of a Si powder and a Ti powder, and mechanical alloying was carried out with a vibration ball mill device in the same manner as in Example 1. In other words, in present Example, there was used a molded negative electrode having the recessed portions opposite to each other on the both flat faces thereof. By using the results of an XRD observation (the position and the half width of the peak) and the Scherrer equation, the crystallite size was calculated to be 18 nm.

### Comparative Example 8

A battery G0 was produced in the same manner as in Comparative Example 1 except that the same negative electrode active material as in Example 16 was used. In other words, in present Comparative Example, there was used a molded negative electrode having no recessed portions on the both flat faces thereof.

### Example 17

A battery H4 was produced in the same manner as in Example 4 except that in the synthesis of the negative electrode active material, a Si powder and a Ni powder were mixed together so as for the molar element ratio to be 74.1:25.9, and mechanical alloying was carried out with a vibration ball mill device in the same manner as in Example 1. In other words, in present Example, by using a Si—Ni alloy in place of the Si—Ti alloy, there was prepared a molded negative electrode having the recessed portions opposite to each other on the both flat faces thereof.

It is to be noted that in the preparation of the negative electrode, the Si—Ni alloy, carbon black as a conductive agent and polyacrylic acid as a binder were mixed together in a weight ratio of 115:20:10 to obtain a negative electrode material mixture.

From the results of an XRD observation, it was revealed that the Si—Ni alloy included at least a Si phase and a NiSi₂ phase. However, because the peak positions were overlapped, the separation of the Si phase and the NiSi₂ phase was impossible. By using the position and the half width of the peak and the Scherrer equation, the crystallite size of the alloy was calculated to be 12 nm. The weight ratio of the Ni—Si phase to the Si phase was found to be 82.6:17.4 under the assumption that all the Ni was involved in the formation of NiSi₂. It is to be noted that the composition of the Ni—Si alloy was determined in such a way that the volume of the Ni—Si alloy after expansion was the same as the volume after expansion of the Ti—Si alloy of Example 1. Additionally, the composition of the negative electrode material mixture was designed in such a way that the volume ratio of the negative electrode active material to the conductive agent to the binder was the same as that in the negative electrode material mixture of Example 4.

### Comparative Example 9

A battery H0 was produced in the same manner as in Comparative Example 1 except that the same negative electrode material mixture as in Example 17 was used. In other words, in present Comparative Example, there was used a molded negative electrode having no recessed portions on the both flat faces thereof.

For each of the batteries, the capacity maintenance rate and the internal resistance increase rate were evaluated. The results thus obtained are shown in Table 2.

TABLE 2

| | | Active | | Capacity maintenance rate | Resistance increase rate |
|---|---|---|---|---|---|
| | Battery | material | Feature | (%) after 100 cycles | (%) after 100 cycles |
| Example 11 | B4 | Graphite | Recessed portions on molded | 95 | 7 |
| | | | body/both faces/opposite | | |
| Comparative | B0 | Graphite | — | 93 | 9 |
| Example 3 | | | | | |
| Example 12 | C4 | Al plate | Recessed portions on molded | 30 | 120 |
| | | | body/both faces/opposite | | |
| Comparative | C0 | Al plate | — | 10 | 156 |
| Example 4 | | | | | |
| Example 13 | D4 | Si | Recessed portions on molded | 93 | 11 |
| | | | body/both faces/opposite | | |
| Comparative | D0 | Si | — | 58 | 63 |
| Example 5 | | | | | |
| Example 14 | E4 | Sn | Recessed portions on molded | 92 | 10 |
| | | | body/both faces/opposite | | |
| Comparative | E0 | Sn | — | 58 | 60 |
| Example 6 | | | | | |
| Example 15 | F4 | SiO | Recessed portions on molded | 89 | 18 |
| | | | body/both faces/opposite | | |
| Comparative | F0 | SiO | — | 56 | 72 |
| Example 7 | | | | | |
| Example 16 | G4 | SnO₂ | Recessed portions on molded | 91 | 16 |
| | | | body/both faces/opposite | | |
| Comparative | G0 | SnO₂ | — | 60 | 64 |
| Example 8 | | | | | |
| Example 17 | H4 | Si—Ni | Recessed portions on molded | 94 | 9 |
| | | alloy | body/both faces/opposite | | |
| Comparative | H0 | Si—Ni | — | 65 | 48 |
| Example 9 | | alloy | | | |

The initial capacity of each of the batteries B4 and B0 was as small as approximately 60% of the initial capacity of any of the other batteries. Irrespective as to whether the recessed portions were present or not, the batteries B4 and B0 each little underwent the cracking of the molded negative electrode, and each exhibited a satisfactory capacity maintenance rate and a low internal resistance increase rate. Although a factor for this is a fact that the capacity and the expansion and contraction magnitude per the volume of the active material during charging and discharging were small, the main reason for this is conceivably the fact that the capacity and the expansion and contraction magnitude per the volume of the molded negative electrode during charging and discharging were small. The apparent volume (the volume inclusive of internal voids) of the molded negative electrode after charging was 1.2 times that before charging.

In each of the batteries C4 and C0, irrespective as to whether the recessed portions were present or not, the molded negative electrode underwent cracking to a large extent, and the continuity break of the current collecting paths along the thickness direction was identified to a large extent. In each of the batteries C4 and C0, the capacity maintenance rate was low and the internal resistance increase rate was large. This is conceivably because the crystallite size of Al was 36 nm to be larger than 20 nm. Conceivably, when the crystallite size is large, even after the molded negative electrode is divided by the cracks generated so as to start from the recessed portions, fracture is generated throughout the molded negative electrode. It is to be noted that in each of the batteries C4 and C0, the apparent volume (the volume inclusive of internal voids) of the molded negative electrode after charging was 2.0 times that before charging.

In the batteries of Examples 13 and 14, when either of the active materials was used, the continuity break of the current collecting paths along the thickness direction was suppressed, and the improvement of the capacity maintenance rate and the suppression of the resistance increase rate were able to be verified. In each of the batteries of Examples 13 and 14, the apparent volume (the volume inclusive of internal voids) of the molded negative electrode was 1.6 times that before charging so as to be approximately constant between the two batteries. This is conceivably ascribable to the fact that the amount of the lithium foil attached to the molded negative electrode was made constant between the two batteries.

### INDUSTRIAL APPLICABILITY

The present invention is particularly effective when a high-capacity Si material and a high-capacity Sn material are used as active materials. Although the structure of a negative electrode including a Si material and a Sn material is hardly stabilized, the structure of such a negative electrode is stabilized according to the present invention. According to the present invention, a drastic enhancement of the capacity is enabled as compared to conventional lithium secondary batteries using carbonaceous materials, and a drastic life extension can be attained as compared to conventional lithium secondary batteries using aluminum plates.

1. A negative electrode for a coin-shaped lithium secondary battery comprising a molded negative electrode including a negative electrode active material capable of absorbing and desorbing lithium, wherein:
the molded negative electrode is of a coin shape having two flat faces and a side edge, and has cracks along the thickness direction thereof; and
at least one of the two flat faces has recessed portions, and the cracks start from the recessed portions.

2. The negative electrode for a coin-shaped lithium secondary battery according to claim 1, wherein the two flat faces each have the recessed portions, and the recessed portions of one flat face and the recessed portions of the other flat face are at least partially opposite to each other.

3. The negative electrode for a coin-shaped lithium secondary battery according to claim 1, wherein the recessed portions are formed in at least one pattern selected from the group consisting of a linear shape, a circular shape, a radial shape, a lattice shape, a polygonal shape and a honeycomb shape.

4. The negative electrode for a coin-shaped lithium secondary battery according to claim 1, wherein the negative electrode active material comprises at least one selected from the group consisting of an alloy of a transition metal and Si, Si, SiOₓ (0<x<2), Sn and SnOₓ (0<x≦2).

5. The negative electrode for a coin-shaped lithium secondary battery according to claim 4, wherein the crystallite size of the negative electrode active material is 20 nm or less.

6. A coin-shaped lithium secondary battery comprising a positive electrode, a positive electrode case that contains the positive electrode, a negative electrode, a negative electrode case that contains the negative electrode, and a separator interposed between the positive electrode and the negative electrode, wherein:
the positive electrode comprises a molded positive electrode including a positive electrode active material capable of absorbing and desorbing lithium;
the negative electrode comprises a molded negative electrode including a negative electrode active material capable of absorbing and desorbing lithium; and
the molded negative electrode is of a coin shape having two flat faces and a side edge, and has cracks along the thickness direction thereof, wherein at least one of the two flat faces has recessed portions, and the cracks start from the recessed portions.

7. The coin-shaped lithium secondary battery according to claim 6, wherein the two flat faces each have the recessed portions, and the recessed portions of one flat face and the recessed portions of the other flat face are at least partially opposite to each other.

8. The coin-shaped lithium secondary battery according to claim 6, wherein the recessed portions are formed in at least one pattern selected from the group consisting of a linear shape, a circular shape, a radial shape, a lattice shape, a polygonal shape and a honeycomb shape.

9. The coin-shaped lithium secondary battery according to claim 6, wherein the negative electrode active material comprises at least one selected from the group consisting of an alloy of a transition metal and Si, Si, SiOₓ, (0<x<2), Sn and SnOₓ (0<x≦2).

10. A coin-shaped lithium secondary battery comprising a positive electrode, a positive electrode case that contains the positive electrode, a negative electrode, a negative electrode case that contains the negative electrode, and a separator interposed between the positive electrode and the negative electrode, wherein:
the positive electrode comprises a molded positive electrode including a positive electrode active material capable of absorbing and desorbing lithium;
the negative electrode comprises a molded negative electrode including a negative electrode active material capable of absorbing and desorbing lithium;
the molded negative electrode is of a coin shape having two flat faces and a side edge, and has cracks along the thickness direction thereof; and
the negative electrode case has raised portions on the face thereof opposite to the molded negative electrode, and the cracks start from the portions where the raised portions are in contact with the molded negative electrode.

11. The coin-shaped lithium secondary battery according to claim 10, wherein the raised portions are formed in at least one pattern selected from the group consisting of a linear shape, a circular shape, a radial shape, a lattice shape, a polygonal shape and a honeycomb shape.

12. The coin-shaped lithium secondary battery according to claim 10, wherein the negative electrode active material comprises at least one selected from the group consisting of an alloy of a transition metal and Si, Si, SiOₓ, (0<x<2), Sn and SnOₓ (0<x≦2).

13. A method for producing a negative electrode for a coin-shaped lithium secondary battery comprising the steps of:
(i) preparing a negative electrode material mixture comprising a negative electrode active material capable of absorbing and desorbing lithium;
(ii) preparing a coin-shaped molded negative electrode having two flat faces and a side edge by press molding the negative electrode material mixture; and
(iii) forming cracks along the thickness direction of the molded negative electrode.

14. The method for producing a negative electrode for a coin-shaped lithium secondary battery according to claim 13, wherein the step (ii) of preparing the molded negative electrode comprises a step of forming recessed portions on at least one of the two flat faces.

15. The method for producing a negative electrode for a coin-shaped lithium secondary battery according to claim 13, wherein the step (iii) of forming the cracks comprises a step in which a negative electrode case having a face having raised portions opposite to the molded negative electrode is supplied, and the molded negative electrode is pressure bonded to the face having the raised portions.

16. The method for producing a negative electrode for a coin-shaped lithium secondary battery according to claim 13, wherein the step (iii) of forming the cracks comprises a step of pressure bonding lithium metal to the molded negative electrode supported by a jig having raised portions.

17. The method for producing a negative electrode for a coin-shaped lithium secondary battery according to claim 13, wherein the step (iii) of forming the cracks comprises a step of pressure bonding lithium metal to the molded negative electrode supported by a jig having recessed portions.

18. The method for producing a negative electrode for a coin-shaped lithium secondary battery according to claim 13, wherein the step (iii) of forming the cracks comprises a step in which a negative electrode case having a face with lithium metal attached thereto opposite to the molded negative electrode is supplied, and the molded negative electrode is pressure bonded to the lithium metal by pushing the molded negative electrode with a jig having raised portions.

19. The method for producing a negative electrode for a coin-shaped lithium secondary battery according to claim 13, wherein the step (iii) of forming the cracks comprises a step in which a negative electrode case having a face with lithium metal attached thereto opposite to the molded negative electrode is supplied, and the molded negative electrode is pressure bonded to the lithium metal by pushing the molded negative electrode with a jig having recessed portions.
